(19) United States
(12) Patent Application Publication
(10) Pub. No.: US 2024/0319786 A1
(43) Pub. Date: Sep. 26, 2024

(54) HUMAN-MACHINE INTERFACE FOR DISPLAYING TACTILE INFORMATION

(71) Applicant: MOTORSKINS UG, Berlin (DE)

(72) Inventors: Facundo GUTIERREZ, Berlin (DE); Juan OPITZ-SILVA, Berlin (DE); José VILLATORO, Berlin (DE); Nils JANSSEN, Berlin (DE)

(21) Appl. No.: 18/681,548

(22) PCT Filed: Aug. 4, 2022
(86) PCT No.: PCT/EP2022/071931

§ 371 Date: Feb. 6, 2024

(30) Foreign Application Priority Data
Aug. 6, 2021 (GB) 2111383.2

(51) Int. Cl. G06F 3/01

(52) U.S. Cl. CPC G06F 3/011; G06F 3/016

(57) ABSTRACT

A human-machine interface (HMI) in a textile for displaying tactile information and/or for detecting a human input. The human-machine interface (HMI) comprises a textile interface element, a control system, and a fluidic connection. The textile interface element comprises at least one chamber, wherein the at least one chamber is arranged between at least one of a top layer and a base layer. The textile interface element is in at least one of a deactivated state, a first activated state, or a second activated state. The control system comprises at least one of electronic elements, a driver module, and a control software. The fluidic connection is fluidly connected to the at least one chamber and the control system, wherein the fluidic connection is used for pumping a fluid into the at least one chamber or removing the fluid from the at least one chamber.

### CROSS REFERENCE TO RELATED APPLICATIONS

This application claims priority to UK Patent Application No. GB 2 111 383 A, filed on 6 Aug. 2021. The entire disclosure of UK Patent Application No. GB 2 111 383 A is hereby incorporated by reference.

### FIELD OF THE INVENTION

The field of the invention relates a human-machine interface (HMI) in a textile for displaying tactile information and for detecting a human input.

### BACKGROUND OF THE INVENTION

Human interaction with a computer requires a user interface. This user interface is used by the human to control the computer. The user interface is usually also used for the computer to feedback information to a user. Physical buttons are often used as human-machine interface to control the computer. A large number of buttons are required for more complex control tasks. Touch screens for displaying information and/or for detecting the human input are therefore more commonly used as human-machine interfaces (HMI) in recent years. These touch screens allow to display items of information and/or detect a human user input based on a current situation and are therefore more flexible than the use of buttons. The touch screens are therefore commonly used in a wide range of applications such as controlling computers, smartphones, or increasingly also cars or other vehicles. Touch screens usually lack tactile guides for the user and therefore require the user to look at a screen in order to identify and select commands for the controlling of the computer, the smartphone, or the vehicle. The use of the touch screen can also cause an information overload to the user from visual signals. Using the touch screen during driving of the vehicle by the user can therefore be distracting and may lead to dangerous driving situations. Solutions for controlling of the computer without visual attention are therefore required.

The prior art teaches solutions such as integrating human-machine interfaces in textiles. The solutions proposed in the prior art rely on tactile interfaces or interface concepts having embedded electronics such as vibration motors, conductive threads, embedded flat pressure sensors. European Patent EP 2 374 049 B1 discloses, for example, a system and method for providing haptic feedback from a haptic flexible structure. The haptic flexible structure comprises a flexible touch surface layer, a haptic substrate, and a deforming mechanism. The flexible touch surface layer is a flexible touch sensitive surface which is capable of accepting user inputs. The flexible touch sensitive surface is divided into multiple regions wherein each region of the flexible touch sensitive surface accepts an input when the region is being touched or depressed by a finger. The haptic substrate is used for providing feedback to the user. The haptic substrate provides feedback to the user using vibration, vertical displacement, lateral displacement, push/pull technique, air/fluid pockets, local deformation of materials, resonant mechanical elements, piezoelectric materials, micro-electro-mechanical systems (“MEMS”) elements, thermal fluid pockets, MEMS pumps, variable porosity membranes, or laminar flow modulation. The deforming mechanism provides a pulling and/or pushing force to translate elements in the haptic substrate causing flexible surface to deform.

The prior art solutions for human-machine interfaces in textiles usually require several layers of textile materials, adhesives, and further functional elements. Theses human-machine interfaces are therefore bulky and recycling of the different materials of these human-machine interfaces poses a significant challenge. Slim and easily recyclable human-machine interfaces for tactile human-machine interaction are therefore required.

### SUMMARY OF THE INVENTION

A human-machine interface (HMI) in a textile for displaying tactile information and/or for detecting a human input is disclosed. The human-machine interface (HMI) comprises a textile interface element, a control system, and a fluidic connection. The HMI architecture is such that the textile interface and the control system are separate and independent of each other, allowing for an upgrade, repair, modification and/or easy exchange of either the textile interface element or the control system without compromising the other. The textile interface element comprises at least one chamber. The at least one chamber is arranged between at least one of a top layer and a base layer. The textile interface element is in at least one of a deactivated state, a first activated state, or a second activated state.

In one aspect, the deactivated state is such that the textile interface element is substantially indistinguishable to touch or sight from a common textile surface in that the at least one chamber cannot be easily seen or felt. This allows for decluttering a visual and/or tactile space and allowing either information to be delivered at the desired moment and only at that desired moment or an information to be input only at a specific time.

In another aspect, sensing (input) and information display (output) take place either in different fluidic circuits or same fluidic circuits. The separation of input (sensing) and output (information display) enables a simpler and more robust control sequence and the possibility to control several different display elements with one input circuit while combining input and output requires fewer electronic elements but more complex software and, for dynamic information display, a textile interface element capable of displaying different levels of information, either through different degrees of swelling or through the use of stacking and/or additional connected textile interface elements. In both cases, the HMI can be used to collect input only and control other elements of the external control system of which the HMI is a part, such as a vehicle or smart home. Different independent circuits can be used as dedicated controls for different functions or devices.

In another aspect, the human-machine interface (HMI) further comprises embedded electronics as a complementary system. This configuration allows, for example, to combine electric and analog (pneumatic or fluidic) signals for gathering or displaying additional information, or the same information in an optimal way. The information transmitted by the HMI can as well be used as a button guide, which would lead the user to, for example, otherwise unseen embedded electronic sensors.

In another aspect, the control system is one of a wireless-capable control system enabling IoT (Internet of Things) capabilities and smart device integration. This could enable the use of the HMI in different configurations for various devices.

In another aspect, the human-machine interface (HMI) further comprises a fluid demultiplexer. The flow of fluid through individual fluid connections in the HMI is regulated indirectly by fluid inputs which can either block the flow of the fluid or enable the flow of the fluid, allowing control of a pre-defined number of independent textile interface elements with fewer actively controlled fluid connections and fewer electronic elements. This allows for more complex functionality and higher resolution of display with fewer electronic elements.

The control system comprises at least one of electronic elements, a driver module, and a control software. The fluidic connection is fluidly connected to the at least one chamber and the control system. The fluidic connection is used for pumping a fluid into the at least one chamber or removing the fluid from the at least one chamber.

A use of the human-machine interface (HMI) in a vehicle for displaying information and/or for detecting a human input is also disclosed.

A use of the human-machine interface (HMI) in a seating for comfort-on-demand and/or remote-control applications is also disclosed.

A feedback method for providing feedback through a textile interface element of the human-machine interface (HMI) is disclosed. The feedback method comprises a rapid partial swelling and a rapid partial deflating of the at least one chamber by electronic elements and repeating of the rapid partial swelling and rapid partial deflating of the at least one chamber. The repeating is perceived as vibrations by a user. The repeating can be utilized for providing a higher degree of information.

In addition, a detection method for detecting an interaction of a user with a human machine interface (HMI) comprising at least one chamber, a first textile interface element, a control system, a swollen top layer, a textile interface element, a fluid connection and an electronic element is disclosed. The detection method comprises a deformation of the swollen top layer by an interaction by the user, changing pressure inside an element of the textile interface element caused by the deformation, transmission of the change in pressure through the fluid connection to the electronic element, detection of the change in pressure by the electronic element, and a recognition of a difference in system pressure. Constant monitoring of the changes in pressure over time can be used to detect several actions such as quick press and release (“fluidic click”), double “fluidic click”, long “fluidic click” or other interaction patterns.

In one aspect, the feedback method or the detection method further comprise generating of different pressure variation patterns by different areas of a first textile interface element, recognizing the different pressure variation patterns by a control system, and processing the different pressure variation patterns by the control system.

### DESCRIPTION OF THE FIGURES

FIG. 1 shows a schematic view of a human-machine interface (HMI) comprising a textile interface element.

FIG. 2A shows a cross-section of the textile interface element.

FIG. 2B shows a cross-section of the textile interface element.

FIG. 3A shows a deactivated state of the textile interface element.

FIG. 3B shows a first activated state of the textile interface element.

FIG. 3C shows second activated state of the textile interface element.

FIG. 4 shows an example for stacking of the chambers and the additional chambers in a third textile interface element.

FIG. 5A shows an exemplary first top layer.

FIG. 5B shows an exemplary second top layer.

FIG. 5C shows an exemplary third top layer.

FIG. 6A shows an aspect of the human-machine interface (HMI).

FIG. 6B shows a further aspect of the human-machine interface (HMI).

FIG. 7 shows a yet another aspect of the human-machine interface (HMI).

FIG. 8 shows a human-machine interface (HMI) comprising at least two fluidic circuits.

FIG. 9 Shows a human-machine interface (HMI) comprising embedded electronics.

FIG. 10 shows a feedback method for providing feedback through the textile interface element of the human-machine interface (HMI).

FIG. 11 shows a detection method for detecting an interaction of a user with the human machine interface (HMI)

### DETAILED DESCRIPTION OF THE INVENTION

The invention will now be described on the basis of the figures. It will be understood that the embodiments and aspects of the invention described herein are only examples and do not limit the protective scope of the claims in any way. The invention is defined by the claims and their equivalents. It will be understood that features of one aspect or embodiment of the invention can be combined with a feature of a different aspect or aspects and/or embodiments of the invention.

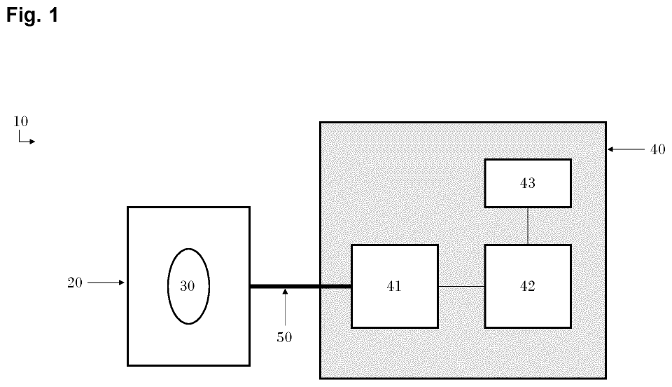

FIG. 1 shows a schematic view of a human-machine interface (HMI) 10 comprising a textile interface element 20, a control system 40, and a fluidic connection 50. The textile interface element 20 is made substantially of textile and/or polymer layers, without embedded electronics or otherwise electrically or magnetically active integrated components. The textile interface element 20 and the control system 40 are independent of each other and can be individually exchanged, upgraded or repaired without affecting the other. The interface element 20 comprises at least one chamber 30. The control system 40 comprises one or more electronic elements 41, a processor or driver module 42, and a control software 43. The electronic elements 41 comprise but are not limited to pumps, valves, mass flow controllers or pressure sensors for liquid or gas.

The fluidic connection 50 fluidly connects the control system 40 and the interface element 20. The electronic elements 41 control and/or monitor a fluid flow to and/or from the textile interface element 20. The controlling of the fluid flow by the electronic elements 41 is done by controlling, for example, a flow, a pressure, and/or a temperature of a fluid flowing in the fluidic connection 50.

The controlling and/or monitoring of the fluid flow by the electronic elements 41 is used for displaying tactile information, using haptic feedback to act on the body and/or detecting a human input. The tactile information is displayed by controlling the fluid flow into the at least one chamber 30. The detecting of the human input is done by, for example, detecting the fluid flow from the at least one chamber 30 to the control system 40. The fluid flow to and/or from the textile interface can of course also be controlled by an external control system (not shown). The external control system is, for example, a control system of a vehicle or another external device, a phone, tablet or IoT-enabled (Internet of Things) device. This external control system can then use the textile interface to apply pressure on the user's body, depending on the area of contact, be it the fingertips or the back, for example, which allows the human-machine interface (HMI) to also act as a comfort on demand element.

The information input on the human-machine interface (HMI) can be detected and processed by the control system 40 or the external control system and used to interact with a separate device or equipment, such as a vehicle or TV. In one aspect, the at least one chamber 30 of the textile interface element 20 can act as buttons-on-demand. In another aspect, the at least one chamber 30 acting as buttons-on-demand can be freely selected in pre-set configurations so as to have different interfaces for different external devices or equipment. In another aspect, the pre-set configurations of buttons on demand can be freely configured and/or reconfigured.

When the human-machine interface (HMI) is not needed, the HMI is discreet and substantially indistinguishable from the rest of the textile surface, which contributes to fewer visual distractions through simple, functional aesthetics. The textile interface element 20 can be used as a covering for underlying systems such as hidden buttons and be used as both a way to hide these controls but also to guide the user towards them when they are required.

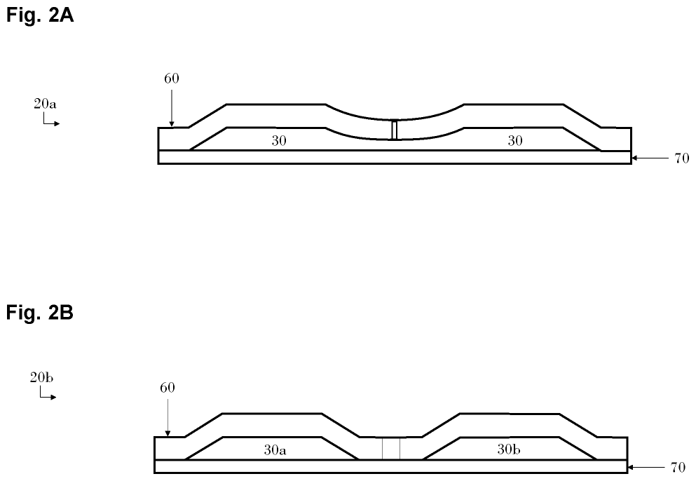

FIG. 2A shows a cross-section of a first textile interface element 20a. The first textile interface element 20a comprises a fluidic circuit comprising one or more chambers 30 embedded between a top layer 60 and a base layer 70. The top layer 60 is affixed to the base layer 70. The affixing comprises mechanical joining such as sewing, riveting, studding, crimping, stapling, or the use of a hook-and-loop fastener such as Velcro. The mechanical joining also comprises welding techniques such as high frequency welding, ultrasonic welding, or laser welding. The mechanical joining further comprises heat sealing and chemical binding through solvents and adhesives.

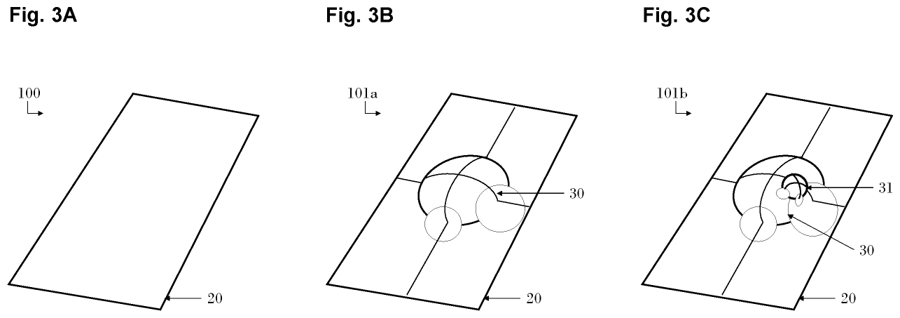

The user interacts with the top layer 60 by, for example, depressing the top layer 60 towards the base layer 70. This depressing of the top layer 60 is the human input. The base layer 70 provides a base onto which the top layer 60 is affixed. The first textile interface element 20a comprises at least one fluid circuit comprising at least one chamber 30 or a network of interconnected chambers 30. The fluid circuit is controlled by the control system 40. The chamber 30 is also referred to as level of information. The level of information is defined as an item of information the user detects when interacting with the textile interface element 20 (see also description of FIG. 3A to FIG. 3C). The level of information corresponds to the filling of the chamber 30 with the fluid by the control system 40. By inflating the chamber 30 with the fluid, the top layer 60 is lifted relative to the base layer 70. This lifting of the top layer 60 is detected by the user by touching the top layer 60 as the item of information indicating the level of information.

FIG. 2B shows a cross-section of a second textile interface element 20b. The second textile interface element 20b comprises the top layer 60 and the base layer 70. The second textile interface element 20b further comprises at least a first chamber 30a and a second chamber 30b. The first chamber 30a and the second chamber 30b are arranged between the top layer 60 and the base layer 70 and are independently actuated by the control system 40.

The base layer 70 defines a shape of the textile interface element 20 including the first textile interface element 20a and the second textile interface element 20b. The shape of the base layer 70 of the textile interface element 20 is, for example, curved, double-curved, wrapped over edges, continuous, or discontinuous. The base layer 70 is made from, for example, polymers, textiles, metal, wood, ceramics, glass, or a combination thereof. In one example, one or more layers are added between the base layer 70 and the top 60 layer to ensure impermeability to a fluid (not shown).

FIG. 3A shows a deactivated state 100 of the textile interface element 20. The top layer 60 is flat in this deactivated state 100 and there are no protrusions on the top layer 60 in this deactivated state 100. The deactivated state 100 is such that the textile interface element 20 is substantially indistinguishable to touch or sight from a common textile surface. The deactivated state 100 results in that the at least one chamber 30 of the textile interface element 20 cannot be easily seen or felt. This allows for decluttering a visual and/or tactile space and allowing either information to be delivered at the desired moment and only then or an information to be input only at a specific time. The timing is decided by the control system 40 or the external control system. For an application inside of a vehicle, the textile interface element 20 can for example transmit information about the outside of the vehicle or the status of its system and/or ask for input based on the same information. The textile interface element 20 can then disappear when it is not required, reducing distractions.

FIG. 3B shows a first activated state 101a of the textile interface element 20. The control system 40 determines a timing at which the fluid is pumped into the at least one chamber 30. The fluid is, for example, air or water. The fluid fills the chamber 30 in this first activated state 101a. The chamber 30 swells and the top layer 60 stretches to a predetermined shape, resulting in the appearance of a pattern that can be detected through touch by the user. The predetermined shape of the chamber 30 is controlled by, for example, a degree of inflation of the chamber 30, a shape or geometry of the chamber 30. The predetermined shape of the chamber 30 is further controlled by, for example, a local variation in a structure of the textile 62. If the textile interface element 20 comprises a single chamber 30, the textile interface element 20 has a single level of information in this first activated state 101a. The chambers 30 are, for example, fluidly connected or independently controlled by the control system 40.

FIG. 3C shows a second activated state 101b of the textile interface element 20. The textile interface element 20 shown in FIG. 3C comprises at least two chambers 30 and 31 and is capable of displaying at least two levels of information. The first level of information can be, for example, general hand placement and comfort, while the second level of information can, for example, provide on demand buttons below the fingertips or haptic feedback fluidic elements. As can be seen from FIG. 3C, the additional chamber 31 protrudes from the surface of the chamber 30. This additional chamber 31 is, in a first example, fluidly connected to the fluid circuit of the chamber 30. The fluid circuit of the additional chamber 31 and the chamber 30 are interdependent. This interdependence of the chamber 30 and the additional chamber 31 is created by fluidly connecting the chamber 30 and the additional chamber 31. The additional chamber 31 and the chamber 30 swell together in this first example.

The additional swollen chamber 31 is, in a second example, fluidly independent of the fluid circuit of the chamber 30. The additional chamber 31 is activated by the control system 40. This activating by the control system 40 is done independently from the controlling of the fluid circuit of the chamber 30. The second activated state 101b is equivalent to the first activated state 101a if only one of the chamber 30 and the additional chamber 31 are activated. If, for example, the additional chamber 31 is activated and the chamber 30 is not activated, the first activated state 101a is equivalent to the second activated state 101b.

Two levels of information are achieved if the chamber 30 and the additional chamber 31 are activated consecutively. The timing of the activating is determined by the control system 40. In activated state 101b of FIG. 3C, only the chamber 30 and the additional chamber 31 are illustrated, but this is not limiting of the invention. The textile interface element 20 comprises, in another example, a plurality of chambers 30 and additional chambers 31. These chambers 30 and the additional chambers 31 are, for example, interconnected or interdependent, and are activated together or independently of each other.

In another example, more than two levels of information are accessed by further stacking of chambers 30 and additional chambers 31 on top of each other. The chambers 30 and additional chambers 31 have, for example, different shapes, patterns, and volumes according to the application requirements and information to transfer. These chambers 30 and additional chambers 31 are, for example, fully or partially stacked on top of each other.

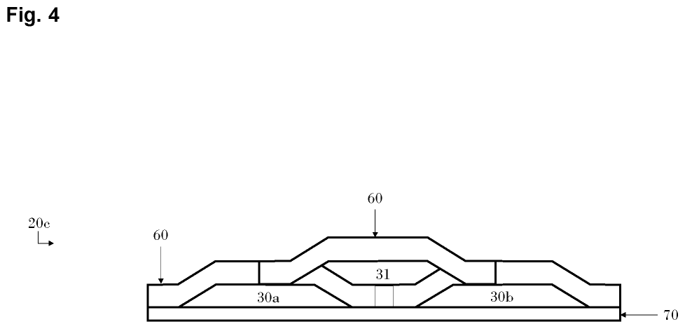

FIG. 4 shows an example of a third textile interface element 20c comprising a first chamber 30a, a second chamber 30b, and at least one additional chamber 31. The additional chamber 31 is at least partially stacked on top of the first chamber 30a and the second chamber 30b. The first chamber 30a, the second chamber 30b, and the at least one additional chamber 31 are arranged beneath the top layer 60. The first chamber 30a and the second chamber 30b are connected to the base layer 70. The additional chamber 31 is not connected to the base layer 70. The first chamber 30a and the second chamber 30b form one level of information. The additional chamber 31 forms an additional level of information. An additional vertical stacking of fluid chambers 31 forms additional levels of information. Vertical stacking is defined as the overlapping of chamber in a way that inflation of the additional chamber results in its at least partial protrusion over the swollen chamber 30 below it.

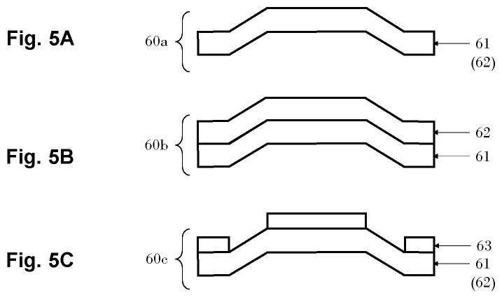

As can be seen from FIG. 5A to FIG. 5C, the top layer 60 comprises at least one layer of material. FIG. 5A shows an example of a first top layer 60a being made of a single polymer layer 61 or of a single layer of textile or coated textile 62. The polymer 61 is, for example, made of a thermoplastic elastomer such as thermoplastic polyurethane or a styrenic block copolymer, but this is not limiting of the invention. The textile 62 is, for example, a stretchable knitted, woven or non-woven textile or a coated textile, but this is not limiting of the invention. The textile material is, for example, a natural or synthetic textile material. The textile material is also, for example, a polymer or an assembly of materials used for, for example, artificial leathers, sustainable materials, and active fabrics.

The textile 62 reversibly stretches due to the mechanical and elastic properties of the material. The textile 62 is, for example, an elastic synthetic or natural yarn. In a further example, the textile can reversibly stretch due to its structure, such as but not limited to knitted textile. In a yet another example, the textile can stretch because of its secondary structure, such as but not limited to patterns cut or engraved on at least one of its surfaces.

FIG. 5B shows an example of a second top layer 60b. The second top layer 60b is made of a multilayer material of at least one polymer layer 61 and one textile layer 62. In this example, the outermost layer is the textile 62 and the innermost layer in the polymer 61 but this is not limiting of the invention.

FIG. 5C shows an example of a third top layer 60c. The third top layer 60c is made of a multilayer material with at least one stretchable layer of polymer 61 or textile 62, or a combination thereof, and one discontinuous layer of inelastic material 63, either textile or polymer, which is only partially affixed to the elastic layer underneath, enabling movement of the elastic layer. In a further example (not shown), the individual layers of the second top layer 60b and/or 60c are not affixed to each other throughout their entire surface but only at key points. It will be understood that the structure of the top layer 60 can vary locally and that these variations in structure—and composition—can have different purposes, such as but not limited to generating an optical or tactile effect or guiding/defining the morphology of the protruding pattern.

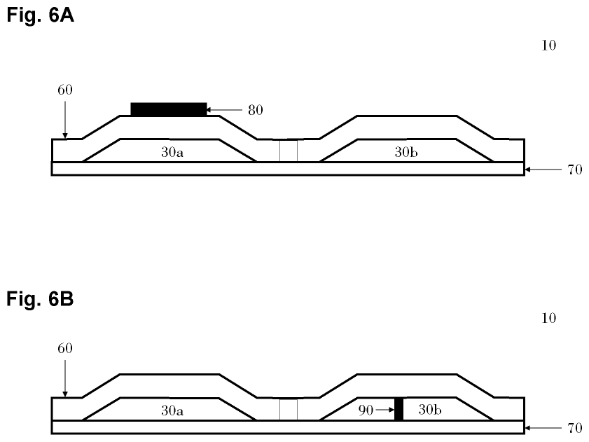

FIG. 6A shows an additional aspect of the human-machine interface (HMI) 10 comprising the first chamber 30a and the second chamber 30b. In the aspect shown in FIG. 6A, an element 80 is added to an exterior surface of the top layer 60 in proximity to the first chamber 30a. The element 80 comprises a rigid material in order to, for example, limit a protruding of a volume of the first chamber 30a. The element 80 is further used for controlling the shape of first chamber 30a or for providing the top layer 60 with a different look and/or feel to the user. The element 80 is provided, for example, on an area corresponding to a pattern of the first chamber 30a and the second chamber 30b. Element 80 can also be included between the layers of the top layer 60 or on the surface of top layer 60 closest to the chamber 30a (innermost surface).

FIG. 6B shows a further aspect in structure of the human-machine interface (HMI) 10 comprising the first chamber 30a and the second chamber 30b. In the aspect shown in FIG. 6B, an element 90 is included between and affixed to the top layer 60 and the base layer 70. The element 90 is, for example, an elastic or inelastic material, rigid or soft, polymer or textile. The element 90 is used to, for example, control or guide an inflation of the chamber 30b, to define a maximum inflation or deflation of the chamber 30b or to enhance a deflation of the chamber 30b by pulling on the top layer 60.

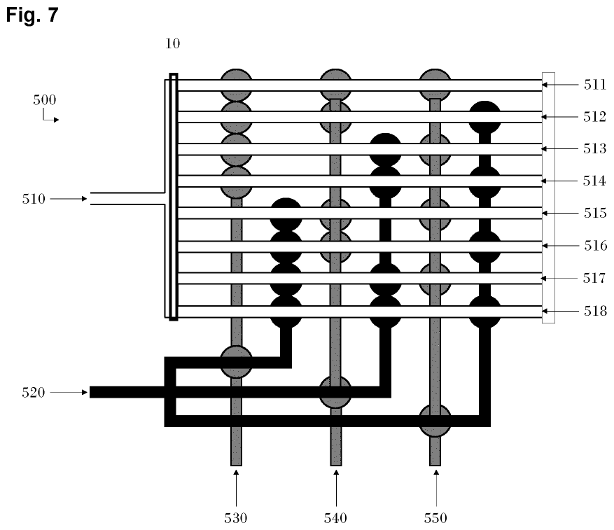

FIG. 7 shows yet another aspect of the human-machine interface (HMI) 10 which contains a large number of independent fluid circuit chambers 30 and/or additional chambers 31. The human-machine interface (HMI) 10 of this aspect further comprises a fluid demultiplexer 500. The fluid demultiplexer 500 is, for example, introduced as a part of the control system 40 of the HMI 10. The fluid demultiplexer 500 is, for example, arranged between the textile interface element 20 and the electronic elements 41. The demultiplexer 500 acts on the simple fluid connections 50 so that the same number of fluid circuit chambers 30 can be controlled with fewer electronic elements 41.

In the aspect of the human-machine interface (HMI) 10 shown in FIG. 7, only five independent fluid inputs 510, 520, 530, 540 and 550 are necessary to independently select eight fluid outputs 511, 512, 513, 514, 515, 516, 517 and 518. In another aspect, one or more of the fluid inputs 510, 520, 530, 540 and 550 can be replaced by valves. In yet another aspect, multiple inputs such as 520 can be replaced by single inputs such as 530, 540 or 550, which increases the number of control elements but allows for more flexibility in output selection of the outputs 511, 512, 513, 514, 515, 516, 517 and 518 and allows to select multiple ones of the outputs 511, 512, 513, 514, 515, 516, 517 and 518 at the same time. In another aspect, the fluidic inputs 520, 530, 540 and 550 are replaced with a series of valves or other elements which directly create mechanical obstruction by pinching or bending the fluid outputs such as but not limited to mobile perforated cards or an analog thereof. In another version, a ternary or quaternary demultiplexer is used. In another version, each fluid output is connected to a special valve, which is in turn connected to two or more fluid inputs. Each fluid input is connected to several valves and each valve is opened only with the correct combination of pressures from the fluid inputs.

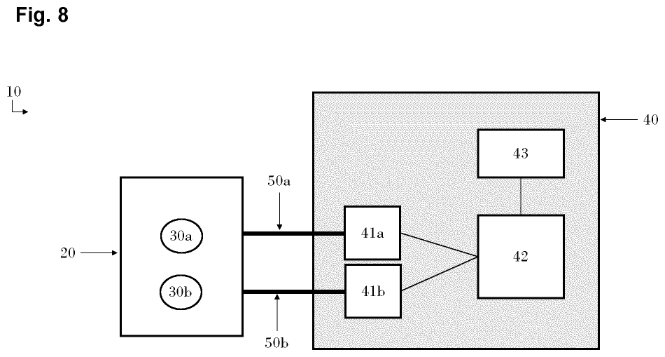

FIG. 8 shows the human-machine interface (HMI) where sensing and display happen in two different fluidic circuits, each fluidic circuit comprising at least one of a first chamber 30a and a second chamber 30b, with at least one of a first independent fluidic connection 50a or a second independent fluid connection 50b, and at least one of a first electronic element 41a or a second electronic element 41b, such as a pump, a valve or a pressure sensor. This configuration makes use of fewer electronic elements 41 while ensuring that the user does not confuse communication of chambers requesting for information input with chambers providing feedback. Thus, information input requested by one of the first chamber 30a and/or the second chamber 30b leads to providing the information input by the other one of the first chamber 30a and/or the second chamber 30b. A dedicated structure, for example the first chamber 30a, for input and a dedicated structure for output, for example the second chamber 30b, reduce the potential for confusion in the user. Multipurpose fluid circuits on the other hand allow for a more versatile interface which can be more freely (re)configured.

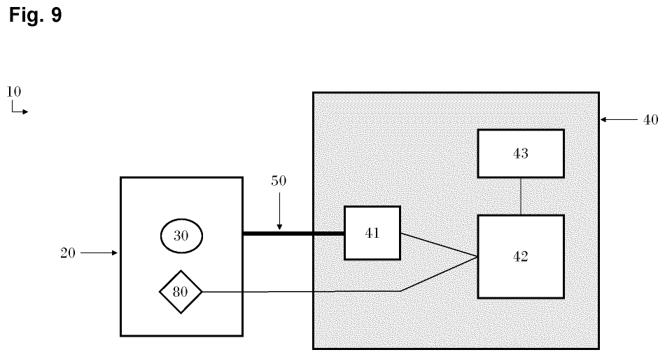

FIG. 9 shows a human-machine interface (HMI) in which embedded electronics 80 are integrated into the textile interface element 20 with one chamber 30, defining an electronic circuit as a complementary system, but this is not limiting of the invention. Both fluidic circuit and electronic circuit are kept separate but can interact through the control system 40, combining different types of shy tech. The term “shy tech”, as used herein, is to be understood as technology that is fully integrated into objects, as for example the control system 40, and thus is non-intrusive, partially or fully disguised, with a front end that aims to be touchable and/or interactive, intuitive, and human-centric. Embedded electronics 80 enhance the visual aspects or the sensing resolution of the HMI. Furthermore, the at least one chamber 30 can act as an on-demand button guide, signaling the position of underlying embedded electronics 80 acting as a button requiring input.

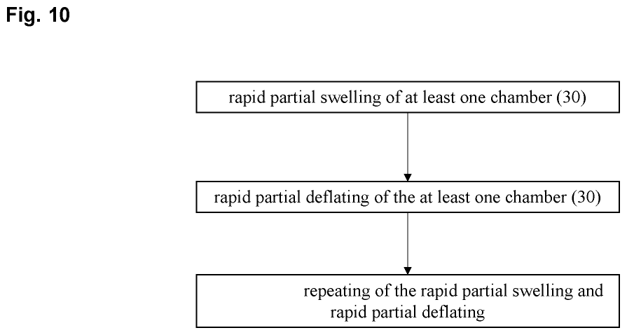

FIG. 10 shows a feedback method for providing feedback through the textile interface element of the human-machine interface. The feedback method comprises the steps of rapid partial swelling of the at least one chamber by electronic elements, rapid partial deflating of the at least one chamber by electronic elements and repeating of the rapid partial swelling and rapid partial deflating of the at least one chamber wherein the repeating is perceived as vibrations by a user. By varying the rate of vibration and combining the vibration with the level of swelling and/or using several or a plurality of textile interface elements 20, information can become more nuanced and richer, transferring additional meaning with fewer textile interface elements 20 and concentrating several types of information into a small, well-defined area for a minimalistic and decluttered interface. This method is compatible with the use of different sensing and display fluid circuits or when sensing and display take place in the same fluid circuit.

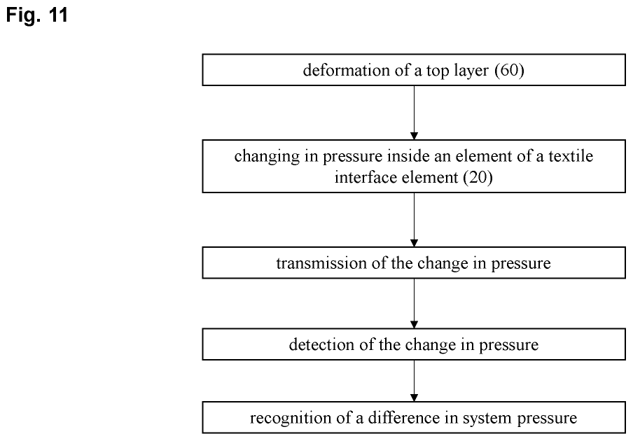

FIG. 11 shows a detection method for detecting an interaction of a user with the human machine interface. The detection method comprises the steps of deforming of the top layer by an interaction of the user, changing in pressure inside an element of the textile interface element caused by the deformation, transmission of the change in pressure through the fluid connection to the electronic element, detection of the change in pressure by the electronic element, and recognition of a difference in system pressure.

The feedback method and the detection method further comprise the steps of generating of different pressure variation patterns by different areas of a first textile interface element, recognizing the different pressure variation patterns by a control system, and processing the different pressure variation patterns by the control system.

Constant monitoring of the changes in pressure over time can be used to detect several actions or other interaction patterns when the user interacts with different areas of the fluid circuit in the textile element 20a. Constantly monitoring changes in pressure also allows to distinguish when the user interacts with different areas of the fluid circuit in the textile element 20a, provided the textile elements 20a have different shapes, volumes or aspect ratios. Combining these two pieces of information, “fluidic clicks”, caused for example by quick press and release, on different areas can be easily distinguished. Moreover, this approach requires fewer independent circuits and allows to reduce the complexity of the hardware by boosting the capability of the software.

In another aspect, the feedback method is applied to a single fluid circuit to which two or more fluidic connections and pressure sensors have been attached (not shown) so as to monitor the pressure at different points of the same fluidic circuit. The difference in response (static response) of the sensors can be used to localize the spot where the user interacts with the textile interface element 20, as well as the difference in response over time (dynamic response). The dynamic response can as well indicate how the user moves through the surface of the activated HMI as they slide for example their finger across the at least one chamber 30 of the fluid circuit in the textile interface. In one aspect, three or more pressure sensors are used to triangulate the interaction spot across a network of interconnected chambers in one fluid circuit of a textile interface element 20.

### REFERENCE NUMERALS

10 human-machine interface (HMI)
20 textile interface element
20a first textile interface element
20b second textile interface element
20c third textile interface element
30 chamber
30a first chamber
30b second chamber
40 control system
41 electronic elements
41a first electronic element 41a
41b second electronic element 41a
42 driver module
43 control software
50 fluidic connection
50a first independent fluidic connection
50b second independent fluidic connection
60 top layer
62 textile
70 base layer
80 embedded electronics
500 fluid demultiplexer
510, 520, 530, 540, 550 fluid input

1. A human-machine interface (HMI) for displaying tactile information and/or detecting a human input, the human-machine interface (HMI) comprising:
a textile interface element comprising at least one chamber, wherein the at least one chamber is arranged between at least one of a top layer and a base layer, and wherein the textile interface element is in at least one of a deactivated state, a first activated state, or a second activated state;
a control system comprising at least one of electronic elements, a driver module, and a control software; and
a fluidic connection fluidly connected to the at least one chamber and the control system, wherein the fluidic connection is used for pumping a fluid into the at least one chamber or removing the fluid from the at least one chamber.

2. The human-machine interface (HMI) according to claim 1, wherein the deactivated state is such that the HMI is substantially indistinguishable to touch or sight from a common textile surface in that the at least one chamber cannot be easily seen or felt.

3. The human-machine interface (HMI) according to claim 1, wherein sensing and information display take place in different fluidic circuits.

4. The human-machine interface (HMI) according to claim 1, wherein sensing and information display take place in the same fluidic circuit

5. The human-machine interface (HMI) according to claim 1, further comprising embedded electronics as a complementary system.

6. The human-machine interface (HMI) according to claim 1, wherein the control system is one of a wireless-capable control system enabling Internet of Things (IoT) capabilities and smart device integration.

7. The human-machine interface (HMI) according to claim 1, further comprising a fluid demultiplexer, wherein the flow of fluid through individual fluid connections is regulated indirectly by fluid inputs which can either block the flow or enable it, allowing to control a pre-defined number of independent textile interface elements with fewer actively controlled fluid connections and fewer electronic elements.

8. Use of the human-machine interface (HMI) according to claim 1, in a vehicle for displaying the tactile information and/or detecting the human input.

9. Use of the human-machine interface (HMI) according to claim 1, in a seating for comfort-on-demand or remote control applications.

10. A feedback method for providing feedback through a textile interface element of the human-machine interface (HMI) according to claim 1, comprising at least one chamber, a control system and a first textile interface element, the feedback method comprising:
rapid partial swelling of the at least one chamber by electronic elements;
rapid partial deflating of the at least one chamber by electronic elements; and
repeating of the rapid partial swelling and rapid partial deflating of the at least one chamber wherein the repeating is perceived as vibrations by a user.

11. A detection method for detecting interaction of a user with a human machine interface (HMI) of claim 1 comprising at least one chamber, a first textile interface element, a control system, a top layer, a textile interface element, a fluid connection and an electronic element, the detection method comprising:
deformation of the top layer by an interaction of the user;
changing in pressure inside an element of the textile interface element caused by the deformation;
transmission of the change in pressure through the fluid connection to the electronic element;
detection of the change in pressure by the electronic element; and
recognition of a difference in system pressure.

12. The method of claim 11, further comprising:
generating different pressure variation patterns by different areas of a first textile interface element;
recognizing the different pressure variation patterns by a control system; and
processing the different pressure variation patterns by the control system.
